(19) United States
(12) Patent Application Publication
(10) Pub. No.: US 2008/0086364 A1
(43) Pub. Date: Apr. 10, 2008

(54) Methods of creating and using a virtual consumer packaged goods marketplace

(76) Inventors: June Irene Hahn, Deerfield Township, OH (US); Michael John North, Wheaton, IL (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/973,053

(22) Filed: Oct. 5, 2007

Related U.S. Application Data
(60) Provisional application No. 60/850,032, filed on Oct. 6, 2006.

(51) Int. Cl. G06Q 10/00

(52) U.S. Cl. 705/10

(57) ABSTRACT

An agent-based computer model having consumer agents, retailer agents, and manufacturer agents represents the major participants in consumer packaged goods markets.

### CROSS REFERENCE TO RELATED APPLICATION

This application claims the benefit of U.S. Provisional Application No. 60/850,032, filed Oct. 6, 2006.

### FIELD OF THE INVENTION

The invention is directed to agent-based computer models to simulate a consumer packaged goods market.

### BACKGROUND OF THE INVENTION

Consumer markets have been studied in great depth using an array of techniques including regression-based modeling, logit modeling, and theoretical market-level models like the NBD-Dirichlet approach. Many contributions and insights have been produced. However, there exists a need to holistically represent the detailed interdependencies commonly found between the decisions and behaviors of consumers, retailers, and manufacturers. While some of the existing methods can in principle represent such interdependencies, the level of detail required for industrial applications can sometimes overwhelm the current capabilities of these techniques. There is a need for a method to address these issues.

Agent-based modeling allows the behavior of system components (i.e., the agents) to be used to forecast the behavior of the overall system. Agent-based modeling is being used to simulate a wide range of systems including industrial supply chains (North and Macal 2007), nascent economies (Padgett and Ansell 1993, Padgett, Lee and Collier 2003), international political systems (Cederman 1997, 2002), possible future energy infrastructures (Stephan and Sullivan 2044), and complex commodity markets (North et al. 2003). See also Casti's (2000) “SimStore”; and Adjali, Dias, and Hurling (2005).

Although there are many techniques for modeling consumer markets, there is generally a need to provide a greater level of detail with regard to the detailed interdependencies between consumers, retailers, and manufacturers. These interdependencies may include the reactions of consumers to combinations of retailer and manufacturer behaviors; the reactions of retailers to other retailers' behaviors; the reactions of manufacturers to other manufacturers' behaviors; the reactions of retailers to manufacturers' behaviors; etc.

For instance, consumer packaged goods manufacturing companies make decisions every day regarding characteristics of their products as well as developing strategies to effectively market their products to consumers. In rendering these decisions, the companies typically must address many issues when seeking to increase sales levels and adapt to marketplace changes. For example, a company may need to react appropriately to a new marketing campaign introduced by a competitor. This step generally requires the company to project the campaign's effects over time on both sales and the consumer's resultant view of the marketplace. The answers in these and other cases are often times counterintuitive due to the complex sequences of interlocking non-linear behaviors commonly found in large-scale competitive consumer packages goods markets. For example, if one consumer goods manufacturer lowers its prices on a product to increase sales, the other manufacturers may react with even lower prices to remain competitive; and, thus, the original manufacturer's sales may actually decrease with a price decrease.

While some of the existing modeling methods can, in principle, represent such interdependencies, they are still limited to estimating either: (a) a small number of steps into the future due to high potential rates of change caused by the feedback that occurs between decisions; or (b) long-run averages that ignore the transient conditions that occur on the way to equilibrium. Furthermore, the levels of detail required for practical applications can sometimes overwhelm the current capabilities of these methods since the amount of data needed for an analysis, generally, is a combinatoric function of the number of variables to be estimated. In other words, these methods often require an enormous amount of data to enable the technique's use. For example, if a company desires to lower the price of a consumer product and wants to gauge the effect on consumers with one of the traditional methods, the company must obtain data over a significantly long period of time when prices were previously lowered, to be able to statistically predict the potential outcome.

Traditional modeling techniques also tend to be limited in: (i) the number of factors that can be included in each analysis; (ii) the level of detail for each factor that can be accommodated in each analysis; and (iii) the behavioral complexity that can be accounted for in each analysis. Consequently, traditional methods usually lack sufficient ability to holistically represent detailed interdependencies commonly found between the decisions and behaviors of consumers, retailers, and manufacturers, as well as computationally representing the inherently non-linear behavior found in consumer packaged goods marketplaces. In other words, the traditional methods typically lack sufficient ability to fully account for the fact that each market participant's subsequent decision is intimately and sensitively dependent on all previous decisions by every other market participant, including themselves.

See also, U.S. Pat. Nos. 6,983,227; 6,985,867; 6,931,365; 5,949,045; 2003/0154092; 2005/0256736.

### SUMMARY OF THE INVENTION

The present invention attempts to address these and other needs by providing in a first aspect of the invention a method of predicting product purchase volume by consumer agents in an agent-based computer model, as an indicium of consumer's purchase behavior, comprising the steps of:

(A) defining, in the agent-based computer model, consumer agents; manufacturer agents; and retailer agents, wherein:
(a) the consumer agents comprise purchasing products during shopper trips at the retailer agents, and
wherein each consumer agent independently comprises:
   (i) a generateable in-store product consideration set;
      wherein the in-store product consideration set is generateable for each shopping trip the consumer agent takes to the retailer agent;
      wherein the in-store product consideration set optionally comprises one or more products, wherein each product, if present, comprises a probability that the consumer agent selects the product for purchase for the shopping trip;
   (ii) an out-of-store product attribute consideration set, wherein each product attribute, if present, of the product attribute consideration set, has a probability of influencing the consumer agent's in-store product consideration set;
(b) the manufacturer agents comprise at least a first manufacturer agent and a second manufacturer agent, wherein the first and second manufacturer agents comprise:
   (i) manufacturing at least a first product and second product, respectively;
   (ii) distributing the first product and the second product, respectively, to the retailer agents;
(c) the retailer agents comprise at least a first retailer agent and a second retailer agent, wherein the first and second retailer agents comprise:
   (i) selling to consumer agents at least a first product or second product distributed by said manufacturer agents;

(B) defining, in the agent-based computer model, a consumer agent purchasing decision filter;

(C) including, in the agent-based computer model, an out-of-store influencer, or an in-store influencer, or a combination thereof;

wherein the out-of-store influencer is capable of influencing the out-of-store product attribute consideration set, and the in-store influencer is capable of influencing the in-store product consideration set;

(D) generating each consumer agent's in-store product consideration set for each shopping trip by the consumer agent by applying the consumer agent purchasing decision filter to compare the consumer agent's out-of-store product attribute consideration set with the products available in the retailer agent where the consumer agent is shopping;

(E) running the agent based model on a computer over a simulated defined time period to obtain the volume of products purchased by the consumer agents from the retailer agents.

Another aspect of the invention provides for methods, systems, and computer program products.

### DETAILED DESCRIPTION OF THE INVENTION

Agent Based Model

The agent based computer model of the present invention can be conducted by any method in the art. In one embodiment, the agent-based modeling toolkit is the Recursive Porous Agent Simulation Toolkit (Repast). The Repast system, including the source code, is available directly from the web. See e.g., http://repast.sourceforge.net/ (including links and references cited therein); and North, M. J. et al., “Experiences Creating Three Implementations of the Repast Agent Modeling Toolkit,” ACM Transactions on Modeling and Computer Simulation, Vol. 16, Issue 1, pp. 1-25, ACM, New York, N.Y., USA (January 2006). Repast includes many features. One such feature includes users' ability to dynamically access and modify agent properties, agent behavioral equations, and model properties at run time. Another feature of Repast includes an automated Monte Carlo simulation framework. Such a feature allows the user to account for random events. Repast is available on virtually all modern computing platforms including WINDOWS, MAC OS, and LINUX. The platform support includes personal computers and large-scale personal computer-based scientific computing clusters. Argonne National Laboratories, Chicago, Ill., USA is an institution that conducts agent-based modeling. Another agent-based modeling toolkit is Swarm. See e.g., http://www.swarm.org.

Another aspect of the invention provides for a manufacturer agent, retailer agent, and a consumer agent. These agents represent the major participants in consumer packaged goods markets such as consumer households, retail participants in consumer packaged goods markets such as retail stores, and manufacturers. The agent relationships represent interactions such as supplier options, competitive responses, and management directives.

Consumer Agent

Generally a consumer agent may be capable of one or more of the following actions: choosing a retail agent, purchasing a product, consuming a product, discussing a product (e.g., social network modeling), and combinations thereof.

The present invention may have from about 1,000 to about 100,000 or more different consumer agents, alternatively from about 5,000 to about 90,000, alternatively from about 10,000 to about 80,000, alternatively from about 20,000 to about 70,000, alternatively from about 30,000 to about 60,000, alternatively from about 40,000 to about 50,000, alternatively 100 to about 1,000,000, alternatively combinations thereof.

In one embodiment, the consumer agents comprise a heterogeneous population. Without wishing to be bound by theory, the heterogeneity of the consumer agents provide for a better model of the behavior observed in the real world than a homogeneous population. A heterogeneous population of agents are created by assigning values for their characteristics by drawing random numbers. These numbers are drawn from statistical distributions whose statistical properties (e.g., mean and standard deviation) are based on measures for a real-life population (such as consumers in the U.S.A.) or are derived from market research data (e.g., a household's desired inventory of goods).

Consumer agents purchase products during shopper trips at retailer agents. Each consumer agent independently comprises an out-of-store product attribute consideration set and an in-store product consideration set.

“Out-of-store product attribute consideration set” means the collections of product attributes above the stock keeping unit (SKU) level that consumers or consumer agents have in mind. The features contained in each out-of-store product attribute consideration set are determined, in one embodiment, by the hierarchy of characteristics of the product category being considered. For example, in a laundry product category, the product attribute may comprise a brand (e.g., TIDE), form (e.g., liquid), and benefit (e.g., bleach). In a dentifrice product category, a product attribute may comprise a brand (e.g. Crest) and a benefit (e.g. whitening). Without wishing to be bound by theory, these hierarchies reflect the fact that consumers' general preferences are formed by high-level attribute bundles, such as a particular brand name, a form, a particular benefit, a scent, etc.

Each product attribute bundle of the out-of-store product attribute set may comprise a probability of influencing how the consumer agent's in-store product consideration set is defined. The assigned probability may account for advertising exposure, advertising decay, product usage experiences, and other activities outside of the retail store environment.

“In-store product consideration set” means the final list of products that are candidates for purchase by the consumer agent during any shopping trip by the consumer agent at a retailer agent. The consumer agent need not purchase a product, but will not purchase a product that is not in the customer agent's in-store product consideration set.

Without wishing to be bound by theory, once a consumer enters a store during a shopping trip, the consumer may choose between different SKUs that match one or more of these product attributes. Price, size, promotional status, etc., now come into the consumer's selection process of product(s) to purchase during the shopping trip. Generally, the “in-store product consideration set” is a temporary set that is created at the beginning of shopping trip, and deleted at the end of the trip, whether or not a product is purchased.

In one embodiment, the list of products in a consumer agent's in-store product consideration set is on a stock keeping unit (SKU) basis and is generated for each shopping trip. In other words, each shopping trip the consumer agents take at the retailer agent need not result in the same products in the in-store product consideration set. Indeed, in one embodiment, a consumer agent need not have a single product in its in-store product consideration set. In another embodiment, the consumer agent may have a plurality of products in its in-store product consideration set, yet the consumer agent may not purchase any product (at the current shopping trip). However, the consumer agent will not purchase a product that is not contained in its in-store product consideration set. The product list may have from about 0 to about 40 products, alternatively from about 5 products to about 30 products, alternatively from about 10 products to about 20 products, alternatively from about 0 to about 10 products, alternatively from about 1 to about 5 products, alternatively from about 2 to about 9 products, alternatively from about 3 to about 8 products, alternatively from about 4 to about 7 products, alternatively from about 5 to about 6 products, alternatively combinations thereof.

The in-store product consideration set for a shopping trip by a consumer agent is generated by applying the consumer agent's purchasing decision filter to compare the consumer agent's out-of-store product attribute consideration set with the products available at-the retailer agent wherein the consumer agent is shopping. It is appreciated that not all retailer agents may offer all the products (e.g., on a SKU-basis) that are potentially available in the market place. For purposes of clarification, applying the purchasing decision filter may limit the number of products in the consumer agent's in-store product consideration set, or may not change the number of products, or may add products to product consideration set (e.g., an acceptable alternative brand may enter the set).

Without wishing to be bound by theory, this “filtering out” of products may be the result of the consumer's lack of full knowledge about some brands, negative past experiences with certain brands, and/or simply not having the cognitive capacity or mental energy to process and weigh current market information about all brands available. The products that remain after this filtering process may comprise the consumer's in-store product consideration set. In one embodiment, the filter is product category specific.

The filter allows model users to specify how each consumer agent considers products from a retailer agent. The filters are model user input parameters that can be changed as needed by the user. A consumer agent's filter is defined using a filter sequencer and a tree of filter steps. The filter steps act as qualifiers. If a filter successfully executes then all “child” filters below it in the tree are also executed, otherwise the child filters are ignored. Each filter step itself may offer a configurable matching process that supports many types of consumer agent decision rules, including construction of in store consideration sets based on matches between product availability at the retailer agent and out of store product attribute consideration sets. Filter steps may also allow products to be added to, removed from, and re-weighted (i.e., probability changed) within the in-store product consideration set. Further, filter steps may also modify the consumer agent's likelihood of purchasing a product on the current shopping trip.

“Household inventory” represents the product stock kept with a given household of a consumer agent. In turn, a “household” is a group of people who live together, and, to some degree, coordinate their shopping. Households typically have one inventory, but may have more than one (e.g., an extra inventory for special stocks such as snacks for invited guests). Like consumer agent purchasing decision filters, inventory policies are user input data that can be changed as needed by model users. Inventory levels and other factors may be factored into each consumer agent's product purchase decisions. In one embodiment, multiple consumer agents may contribute to each inventory (e.g., primary and secondary shoppers may supply the main household inventory). In a second embodiment, each inventory, in turn, may act to supply multiple consumer agents.

The status of a consumer agent's particular household inventory may increase/decrease the probability that a consumer agent will purchase a product during a shopping trip. For example, if the household inventory of a consumer agent is relatively low or depleted, there is generally an increase in the probability that the consumer agent will purchase a product during a shopping trip. Of course if the household inventory of a consumer agent's inventory is relatively full or complete, there is generally a decrease in the probability that the consumer agent will purchase a product during a shopping trip.

“Out-of-store influencer” represents those influences, by the retailer agent, or manufacturer agent, or combination thereof, that typically occur outside of a retail store, and which may influence a consumer agent's out-of-store product attribute consideration set. The influencer may be directed to inclusion/exclusion of one or more product attributes of the consumer agent's product attribute consideration set, or increasing/decreasing the probability associated with one or more product attributes in the product attribute consideration set (which in turn influence construction of the consumer agent's in-store product contribution set), or a combination thereof. Non-limiting examples of out-of-store influencers may include advertising through print media, internet, television, radio, or cell phone, coupon distribution through circulars, etc. In one embodiment, the out-of-store influencer may be further defined by degree represented by GRP (Gross Rating Point) or other indicia of advertising viewing exposure.

“In-store influencer” represents those influences, by the retailer agent, or manufacturer agent, or combination thereof, that typically occur within a retail store, and which may influence a consumer agent's in-store product consideration set. The influencer may be directed to inclusion/exclusion of one or more products of the consumer agent's product consideration set, or increasing/decreasing the probability associated with one or more products in the product consideration set, or a combination thereof. Non-limiting examples of in-store influencers may include in-store coupons, in-store price reductions, in-store promotions, in-store displays, etc. In one embodiment, the in-store influencer may by further defined by degree represented by a GRP of other indicia of in-store advertising. See e.g., P.R.I.S.M. (Pioneering Research for an In-Store Metric Initiative). Young, Kathryn, and George Wishart, “Valuing In-Store Marketing Transforming the Store into a Measured Medium, An Overview of the P.R.I.S.M. Initiative,” (2007).

“Simulated defined time period” means the time period the agent-based computer model is set to simulate. For example, the model may be set to simulate 1, 2, 3, 4, 5, 6, 7, 8, 9, 10 years or more to predict the volume of product(s) purchased by the consumer agents. Of course, depending upon the computing power of the computer, the model can be run in a matter of minutes to simulate weeks, months, or years of the simulated market place. The purchased product volume, in turn, can be used to determine the effectiveness of a strategy, or a competitive response, changes in a market share of a product, and other indicium that is based upon the volume of product(s) purchased by consumer agents during the course of the simulated defined time period of the model.

Manufacturer Agent

Generally a manufacturer agent may be capable of one or more of the following actions: creating a product, manufacturing a product, distributing a product, advertising a product (in and out of store advertising), providing trade funds to the retailer, and/or providing retailer product promotion support.

The manufacturer agents comprise at least a first manufacturer agent and a second manufacturer agent, wherein the first and second manufacturer agents comprise: manufacturing at least a first product and second product, respectively; and distributing the first product and the second product, respectively, to retailer agents.

The present invention may have 1, 2, 3, 4, 5, 6, 7, 8, 9, 10 or more different manufacturers or manufacturer agents. The products manufactured by the manufacturers may comprise consumable products. Alternatively, the products are non-durable consumable products. Alternatively, in one embodiment, the term “products” excludes services (e.g., telecommunication services).

Exemplary product forms and brands are described on The Procter & Gamble Company's website, www.pg.com, and the linked sites found thereon. It is to be understood that consumer products that are part of product categories other than those listed above are also contemplated by the present invention, and that alternative product forms and brands other than those disclosed on the above-identified website are also encompassed by the present invention.

Retailer Agent

Generally a retailer agent may be capable of one or more of the following actions: creating a store, distributing a circular advertising a product, stocking a store's shelves of a product, presenting a promotion for a product, running a sale on a product; and combinations thereof.

Retailer agents comprise at least a first retailer agent and a second retailer agent, wherein the first and second retailer agents comprise: selling to consumer agents products distributed by manufacturer agents. The present invention may have 1, 2, 3, 4, 5, 6, 7, 8, 9, 10 or more retailer agents.

Retailer agents may be further organized hierarchically into retail store agents, retail region agents, and retail channel agents.

Retailer agents represent locations for purchasing goods, preferably on a product category basis. In embodiment, retail stores are grouped into neighborhoods. Each neighborhood contains a set of competing stores as well as a population of consumer agents who visit the stores. Each neighborhood contains a representative for each retail channel. Since each retail channel may have a different number of stores (e.g., there are many more drug stores than club stores in America), individual stores may be in more than one neighborhood. Store membership in multiple neighborhoods creates the potential for networks of neighborhoods to form. The constraints for neighborhood formation are specified by the user with input data.

In another embodiment, retail neighborhoods are grouped to form retail regions. Regions may be used to reflect varying store stocking, promotions, features, preferences, etc. on a broad geographic basis. The number of regions may depend on the product category and area being modeled.

In yet another embodiment, each retail store belongs to one of several retail channels. Each retail channel represents either a type of retailer (e.g., food stores) or a specific retailer. Channel-level data may be used when there are a large number of small retailers with similar stores and strategies or when higher-level results are needed. Data for specific named retailers is used when there are a small number of large retailers or detailed results are needed. Hybrid combinations of channel-level and named retailers can also be used when mixtures of results are needed. Retailer channel information is provided as user-defined input data.

Application

Possible non-limiting applications of the agent-based model of the present invention include supporting robustness testing of market strategies and to allow the potential causes of trends to be explored. For example, imagine that a first manufacturer is hypothetically considering reducing the price of its laundry detergent. The model is likely not best at predicting if a competitor manufacturer will reduce the price of a competing laundry detergent in response to the first manufacturer. However, the model can automatically generate a range of potential response scenarios, each describing a possibility of what might happen in response to the first manufacturer's price cut. If a large number of diverse response scenarios are executed and all of the response scenarios are favorable, then it might be concluded that a price reduction is relatively “safe.” If some or many of the scenarios are unfavorable, then it might be concluded that a price reduction is risky. The model allows for a diverse range of potential market outcomes to be explored in an efficient and objective manner.

In addition to supporting robustness testing, the model is intended to allow the potential causes of trends to be explored. For example, imagine that there are several competing theories as to why certain coupon distribution schedules tend to increase sales significantly above that of other kinds of coupon distribution schedules. It may be difficult and expensive to test these theories in actual markets. The model provides an efficient platform for each of the theories to be tested. To complete the tests, input scenarios and possibly agent software representing each of the candidate explanations can be configured and executed in the model, often using many stochastic replications. The results from the model runs can then be compared to the observed market effects. If there are significant mismatches between the model results and the real market outcomes for a given theory, then that theory is probably not correct, at least for the range covered by the observed data. Of course, the reverse may not be true. Reproducing one market outcome does not guarantee that the theory is correct. This coarse filter turns out to be powerful in practice. The model is used to demonstrate that several strongly held ideas about consumer behavior do not successfully reproduce observed market outcomes.

Systems

Yet another aspect of the invention provides for methods, systems and computer program products. The systems of the present invention includes at least one computer-readable medium used for storing computer instructions, data, models of the present invention, output from said models, program product, and the like. A general example of a computer is described in US 2006/0010027 A1, paragraph 78. Examples of computer readable media are compact discs, hard disks, floppy disks, tape, magneto-optical disks, PROMs (EPROM, EEPROM, Flash EPROM, etc.), DRAM, SRAM, SDRAM, etc. Stored on any one or on a combination of computer readable media, the present invention includes software for controlling both the hardware of the computer and for enabling the computer to interact with a human user. Such software may include, but is not limited to, device drivers, operating systems and user applications.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

1. A method of predicting product purchase volume by consumer agents in an agent-based computer model, as an indicium of consumer's purchase behavior, comprising the steps of:
(A) defining, in the agent-based computer model, consumer agents; manufacturer agents; and retailer agents, wherein:
(a) the consumer agents comprise purchasing products during shopper trips at the retailer agents, and
wherein each consumer agent independently comprises:
(i) a generateable in-store product consideration set;
wherein the in-store product consideration set is generateable for each shopping trip the consumer agent takes to the retailer agent;
wherein the in-store product consideration set optionally comprises one or more products, wherein each product, if present, comprises a probability that the consumer agent selects the product for purchase for the shopping trip;
(ii) an out-of-store product attribute consideration set, wherein each product attribute, if present, of the product attribute consideration set, has a probability of influencing the consumer agent's in store product consideration set;
(b) the manufacturer agents comprise at least a first manufacturer agent and a second manufacturer agent, wherein the first and second manufacturer agents comprise:
(i) manufacturing at least a first product and second product, respectively;
(ii) distributing the first product and the second product, respectively, to the retailer agents;
(c) the retailer agents comprise at least a first retailer agent and a second retailer agent, wherein the first and second retailer agents comprise:
(i) selling to consumer agents at least a first product or second product distributed by said manufacturer agents;
(B) defining, in the agent-based computer model, a consumer agent purchasing decision filter;
(C) including, in the agent-based computer model, an out-of-store influencer, or an in-store influencer, or a combination thereof;
wherein the out-of-store influencer is capable of influencing the out-of-store product attribute consideration set, and the in-store influencer is capable of influencing the in-store product consideration set;
(D) generating each consumer agent's in-store product consideration set for each shopping trip by the consumer agent by applying the consumer agent purchasing decision filter to compare the consumer agent's out-of-store product attribute consideration set with the products available in the retailer agent wherein the consumer agent is shopping;
(E) running the agent based model on a computer over a simulated defined time period to obtain the volume of products purchased by the consumer agents from the retailer agents.

2. The method of claim 1, wherein the product of the in-store product consideration set matches product attribute of the out-of-store product attribute consideration set.

3. The method of claim 1, wherein the out-of store product attribute consideration set changes for the consumer agents during the course of the simulated defined time period.

4. The method of claim 3, wherein the simulated defined time period comprises from about 1 month to about 2 years.

5. The method of claim 1, wherein the number of consumer agents comprises from about 500 to about 100,000.

6. The method of claim 1, wherein each consumer agent is assigned to a specific retailer agent.

7. The method of claim 1, wherein the first product and the second product each belong to the same product category.

8. The method of claim 1, wherein the first and second manufacturers are competitors to each other.

9. The method of claim 1, wherein the first and second products are consumable packaged goods.

10. The method of claim 1, wherein the consumer agents comprise a heterogeneous population of agents.

11. The method of claim 1, wherein the product attribute consideration set comprises: a brand, product form, product benefit, or combination thereof.

12. The method of claim 1, wherein the products of the products consideration set, comprises from about 1 to about 10 products.

13. The method of claim 1, wherein the consumer agent comprises an household inventory, wherein the consumer agent's household inventory is factored into the probability that the consumer agent will purchase a product in the shopping trip.
